(19) United States
(12) Patent Application Publication
(10) Pub. No.: US 2020/0294385 A1
(43) Pub. Date: Sep. 17, 2020

(54) VEHICLE OPERATION IN RESPONSE TO AN EMERGENCY EVENT

(71) Applicant: General Motors LLC, Detroit, MI (US)

(72) Inventors: Dexter C. Lowe, Macomb, MI (US); MaryAnn Adams, Plymouth, MI (US)

(21) Appl. No.: 16/354,877

(22) Filed: Mar. 15, 2019

(51) Int. Cl. G08B 25/00; H04W 4/46; G07C 5/00

(52) U.S. Cl. CPC G08B 25/005; G07C 5/008; H04W 4/46

(57) ABSTRACT

A system and method for causing a responsive vehicle action to be carried out at one or more affected vehicles in response to an emergency event. The method includes: identifying probe vehicle(s) in response to an emergency event indication, wherein the probe vehicle(s) are selected based on a proximity between an emergency event location and the vehicle(s) or a route of the vehicle(s); sending a data request to the probe vehicle(s); receiving a data response from the probe vehicle(s) at the remote server, wherein the probe data is based on onboard sensor data obtained from one or more onboard vehicle sensors; and sending a responsive vehicle action message to the affected vehicle(s), wherein the responsive vehicle action message specifies responsive vehicle action(s) to be carried out by the affected vehicle, and wherein at least one of the one or more responsive vehicle actions are determined based on the probe data.

The present invention relates to collecting vehicle data in response to an identified emergency or crisis, as well as providing a responsive action to vehicles impacted or affected, or potentially impacted or affected, by the identified emergency or crisis.

Vehicles include hardware and software capable of obtaining and processing various information, including information that is obtained by onboard vehicle sensors. These onboard vehicle sensors can capture sensor data concerning the surroundings of the vehicle. In some instances, a vehicle's route may be affected by an emergency or crisis, such as a forest fire or other fire/explosion, collapsed or impassible bridges or other roadways, flooded roadways, etc. These emergencies or crises are referred to herein as “emergency events.”

### SUMMARY

According to one aspect of the invention, there is provided a method for causing a responsive vehicle action to be carried out at one or more affected vehicles in response to an emergency event. The method includes: identifying one or more probe vehicles in response to an emergency event indication, wherein the one or more probe vehicles are selected based on a proximity between an emergency event location of the emergency event and the one or more vehicles or a route of the one or more vehicles; sending a data request to the one or more probe vehicles, wherein the data request indicates to the one or more probe vehicles to send probe data to a remote server; receiving a data response from the one or more probe vehicles at the remote server, wherein the data response includes the probe data, and wherein the probe data is based on onboard sensor data obtained from one or more onboard vehicle sensors; and sending a responsive vehicle action message to each of the one or more affected vehicles, wherein the responsive vehicle action message specifies one or more responsive vehicle actions to be carried out by the affected vehicle to which the responsive vehicle action message is sent, wherein at least one of the one or more responsive vehicle actions are determined based on the probe data.

According to various embodiments, this method may further include any one of the following features or any technically-feasible combination of some or all of these features:
receiving the emergency event indication, wherein the emergency event indication includes the emergency event location and an emergency event type;
the data request is generated based on the emergency event type;
the responsive vehicle action is determined based on the emergency event type and/or the probe data;
the responsive vehicle action is determined based on vehicle physical attribute information that is stored in a database of a remote facility;
the one or more affected vehicles are selected based on a proximity to the emergency event location, whether a planned route of the vehicle passes through the emergency event location, and/or whether the vehicle resides at, within, or near the emergency event location;
the data request specifies a probe data type, a probe data source, and/or a probe data location;
the probe data source specifies a particular onboard vehicle sensor that is to be used to collect the probe data;
at least one of the responsive vehicle actions specified in the responsive vehicle action message sent to a first affected vehicle is determined based on vehicle physical attribute information of the first affected vehicle;
the at least one responsive vehicle action is determined based on the probe data that is received from a first one of the one or more probe vehicles, wherein vehicle physical attribute information of the first probe vehicle is the same as or corresponds to the vehicle physical attribute information of the first affected vehicle;
the probe data of at least one of the data responses from a first probe vehicle of the one or more probe vehicles includes vehicle-to-vehicle (V2V) data that is obtained by the first probe vehicle using short-range wireless communication (SRWC) circuitry; and/or
sending emergency event data updates periodically to one or more of the probe vehicle(s) and/or the affected vehicle(s) in response to the remote server receiving updated emergency event data.

According to another aspect of the invention, there is provided a method of causing a responsive vehicle action to be carried out at one or more affected vehicles in response to an emergency event. The method includes: receiving a data request from a backend facility at a first vehicle, wherein the data request indicates to the one or more probe vehicles to send probe data to the backend facility, and wherein the data request is generated at the backend facility in response to an emergency event indication; obtaining onboard sensor data from one or more onboard vehicle sensors of the vehicle; generating a data response at the vehicle based on the onboard sensor data, wherein the data response includes the probe data, and wherein the probe data includes the onboard sensor data or data based on the onboard sensor data; and sending the data response to the backend facility, wherein at least some of the probe data of the data response is used by the backend facility to generate one or more responsive vehicle action messages that each specify one or more responsive vehicle actions to be carried out by one or more affected vehicles to which the responsive vehicle action message is sent.

According to various embodiments, this method may further include any one of the following features or any technically-feasible combination of some or all of these features:
the method is carried out by the first vehicle, and wherein the first vehicle is a probe vehicle;
the onboard vehicle sensors include an environmental sensor that captures information of a vehicle environmental state;
the environmental sensor is a water sensor, a lidar unit, a radar unit, or a camera;
the first vehicle is one of the one or more affected vehicles, wherein the method further includes the steps of: receiving a first one of the responsive vehicle action messages from the backend facility; and carrying out the responsive vehicle action specified in the first responsive vehicle action message;
the first responsive vehicle action message is generated based on the probe data included in the data response received at the backend facility from the first vehicle;
the first responsive vehicle action message is generated based on probe data included in another data response received at the backend facility from another probe vehicle; and/or
the first vehicle is an autonomous vehicle (AV), wherein the first vehicle determines whether to continue AV driving functionality based on emergency event information received from the backend facility.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flowchart of an embodiment of a method of causing a responsive vehicle action to be carried out at one or more affected vehicles in response to an emergency event;

FIG. 3 is a flowchart of an embodiment of a method of causing a responsive vehicle action to be carried out at one or more affected vehicles in response to an emergency event; and

FIG. 4 is a flowchart of an embodiment of carrying out a responsive vehicle action for an autonomous vehicle that can be used with the method of FIG. 2 and/or the method of FIG. 3.

### DETAILED DESCRIPTION

The system and method described below enables a responsive vehicle action to be carried out in response to an emergency event. According to various embodiments, the system and method described herein can be used to identify one or more probe vehicles in response to an identified emergency event, obtain probe data from the one or more probe vehicles, identify one or more affected vehicles that are affected (or potentially affected) by the emergency event, and cause a responsive vehicle action to be carried out by the affected vehicle(s). In one embodiment, the responsive vehicle action can include presenting a warning or other notification to a vehicle user at the vehicle, and/or can include re-routing the vehicle around or away from the emergency event. And, in one embodiment, the responsive vehicle action can include carrying out autonomous vehicle (AV) functionality that is adapted based on the probe data and/or other information gathered concerning the emergency event.

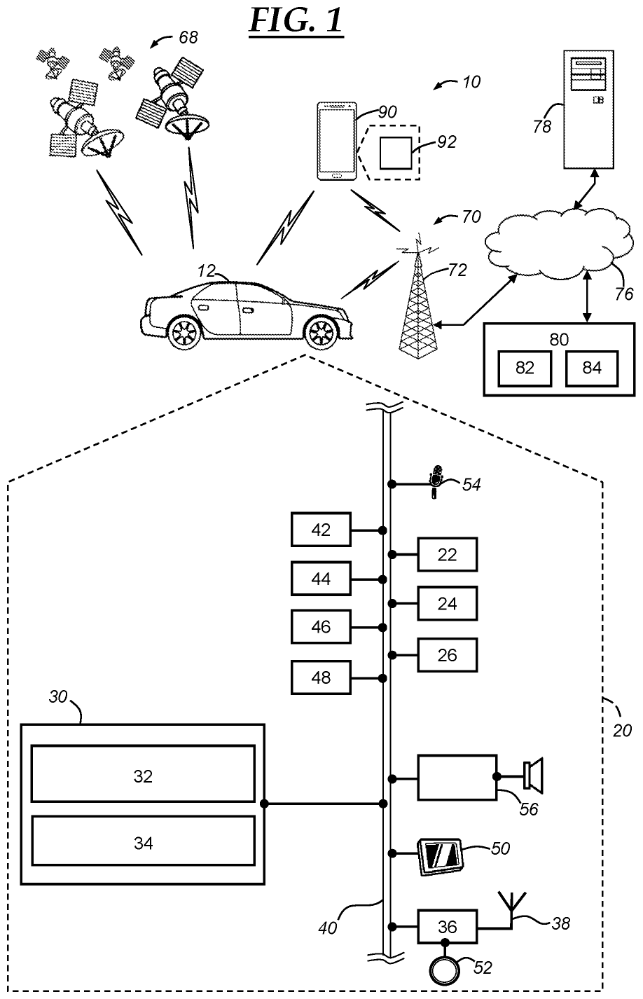

With reference to FIG. 1, there is shown an operating environment that comprises a communications system 10 and that can be used to implement the method disclosed herein. Communications system 10 generally includes a vehicle 12, a constellation of global navigation satellite system (GNSS) satellites 68, one or more wireless carrier systems 70, a land communications network (referred to herein as “land network”) 76, a remote server 78, a backed vehicle services facility 80, and a handheld wireless device (HWD) 90. It should be understood that the disclosed method can be used with any number of different systems and is not specifically limited to the operating environment shown here. Also, the architecture, construction, setup, and general operation of the system 10 and its individual components are generally known in the art. Thus, the following paragraphs simply provide a brief overview of one such communications system 10; however, other systems not shown here could employ the disclosed methods as well.

Wireless carrier system 70 may be any suitable cellular telephone system. The wireless carrier system 70 is shown as including a cellular tower 72; however, the wireless carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., telematics unit 36 of the vehicle 12, HWD 90). The wireless carrier system 70 can implement any suitable communications technology, including GSM/GPRS technology, CDMA or CDMA2000 technology, LTE technology, etc. In general, the wireless carrier systems 70, their components, the arrangement of their components, the interaction between the components, etc. is generally known in the art.

Apart from using the wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of the wireless carrier system 70.

Land network 76 may be a conventional land-based telecommunications network that is connected to one or more landline telephones and connects the wireless carrier system 70 to the remote server 78 and/or the vehicle backend services facility 80. For example, the land network 76 may include a public switched telephone network (PSTN) such as that used to provide hardwired telephony, packet-switched data communications, and the Internet infrastructure. One or more segments of the land network 76 could be implemented through the use of a standard wired network, a fiber or other optical network, a cable network, power lines, other wireless networks such as wireless local area networks (WLANs), or networks providing broadband wireless access (BWA), or any combination thereof.

Remote server(s) (or computer(s)) 78 (referred to collectivity as the “remote server”) (only one shown) can include any of a number of servers or computers accessible via a private or public network such as the Internet. In one embodiment, each such remote server 78 can be used for one or more purposes, such as for providing a vehicle user computer application that allows a user to access vehicle information and/or control certain vehicle functionality. In one embodiment, the remote server 78 can support (e.g., act as a server for) a vehicle user application 92 that is carried out by the HWD 90. Additionally or alternatively, such accessible remote servers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12, backend facility 80, or both.

In one embodiment, the remote server 78 represents one or more remote servers that provide information to other systems, devices, or networks, such as the backend facility 80. Any one or more of these servers 78 can provide data using an application programming interface (API), such as those that are connectable using the Internet or other remote network connection. For example, a remote weather server 78 can be used to provide weather information, a remote traffic server 78 could be used to provide traffic information (e.g., including current traffic conditions, traffic signal timing or other information), a remote roadway server 78 could be used to provide information pertaining to various roadways (e.g., roadway map information), and/or a remote emergency system server 78 could be used to provide information pertaining to emergency events. Other such remote servers 78 are possible, as these aforementioned servers are only provided for exemplary purposes.

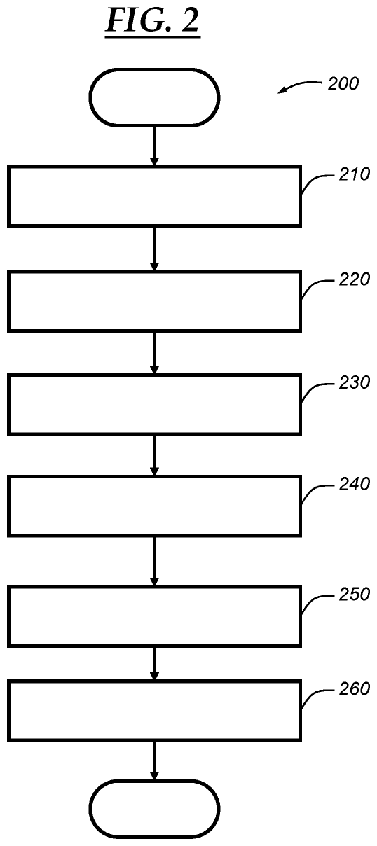

Vehicle backend services facility (or “backend facility” for short) 80 is a remote facility and is located at a physical location that is located remotely from the vehicle 12. The backend facility 80 may be designed to provide the vehicle electronics 20 with a number of different system back-end functions through use of one or more electronic servers 82. In one embodiment, the backend facility 80 can carry out the method 200 below (FIG. 2). The vehicle backend services facility 80 includes vehicle backend services servers 82 and databases 84, which may be stored on a plurality of memory devices. The vehicle backend services facility 80 may include any or all of these various components and, in at least some embodiments, each of the various components are coupled to one another via a wired or wireless local area network. The backend facility 80 may receive and transmit data via one or more modems connected to the land network 76. Data transmissions may also be conducted by wireless systems, such as IEEE 802.11x, GPRS, and the like. Those skilled in the art will appreciate that, although only one backend facility 80 and one remote server 78 are depicted in the illustrated embodiment, numerous backend facilities 80 and/or remote servers 78 may be used. Moreover, a plurality of backend facilities 80 and/or remote servers 78 can be geographically distributed and can each coordinate information and services with one another, as those skilled in the art will appreciate.

Servers 82 can be computers or other computing devices that include at least one processor and that include memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services, such as the carrying out of one or more method steps as discussed below. This software may be stored in computer-readable memory, which can include or be any suitable non-transitory, computer-readable medium. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives. For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. The backend facility 80 can include a number of routers, modems, switches, or other network devices that can be used to provide networking capabilities, such as connecting with the land network 76 and/or the cellular carrier system 70.

Databases 84 can be stored on a plurality of memory, such as a powered temporary memory or any suitable non-transitory, computer-readable medium. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and/or magnetic or optical disc drives. One or more databases 84 at the backend facility 80 can store various information and can include vehicle location monitoring information, which can include locations (e.g., geographical locations) of various vehicles at different times so as to track and/or monitor the location of such vehicles. The databases 84 can also store emergency event information, such as any or all of the information used in the method(s) below, including, for example, vehicle attribute information and/or probe data obtained from a plurality of vehicles (such as for a fleet of vehicles). The vehicle attribute information is information that specifies certain characteristics of a particular vehicle, such as vehicle model information (e.g., the make, the model, the model-year, etc. of the vehicle) and vehicle physical attribute information (e.g., the underbody clearance height, drivetrain capabilities (e.g., four-wheel drive, all-wheel drive, two-wheel drive, torque or power output), traction information, wheel/tire size, vehicle height, vehicle weight, vehicle width). The probe data includes onboard sensor data that is captured from one or more probe vehicles, which are vehicles that are identified as being those vehicles located near (e.g., within a predetermined distance from) or at an identified emergency location, or en route to an identified emergency location. The probe data can also include other information or data besides the onboard sensor data, including GNSS data, information obtained from a vehicle user (e.g., via a vehicle-user input), etc.

The handheld wireless device (HWD) 90 is a mobile device and a short-range wireless communication (SRWC) device (i.e., a device capable of SRWC (e.g., Bluetooth™, Wi-Fi™)) and may include: hardware, software, and/or firmware enabling cellular telecommunications and SRWC as well as other mobile device applications, such as a vehicle user computer application 92. The hardware of the HWD 90 may comprise: a processor and memory for storing the software, firmware, etc. The HWD processor and memory may enable various software applications, which may be preinstalled or installed by the user (or manufacturer). In one embodiment, the HWD 90 includes a vehicle user application 92 that enables a vehicle user to communicate with the vehicle 12 (e.g., such as inputting route or trip parameters) and/or control various aspects or functions of the vehicle, some of which are listed above. Additionally, one or more applications may allow the user to connect with the backend facility 80 or call center advisors.

In some embodiments, the HWD 90 is a personal SRWC device. As used herein, a personal SRWC device is a mobile device that is capable of SRWC, that is portable by a user, and where the portability of the device is at least partly dependent on the user, such as a wearable device (e.g., a smartwatch), an implantable device, or a handheld device (e.g., a smartphone, a tablet, a laptop). As used herein, a short-range wireless communications (SRWC) device is a device capable of SRWC. In one particular embodiment, the HWD 90 can be a personal cellular SRWC device that includes a cellular chipset and/or cellular connectivity capabilities, as well as SRWC capabilities. Using a cellular chipset, for example, the HWD 90 can connect with various remote devices, including the remote servers 78 and the servers 82 of the backend facility 80 via wireless carrier system 70 and/or land network 76.

The vehicle user application 92 is an application that enables the user to view information pertaining to the vehicle 12. In some embodiments, the vehicle user application 92 enables the user to send commands to the vehicle, such as to remotely start the vehicle's engine (or other primary propulsion system), to lock/unlock vehicle doors, etc. The vehicle user application 92 can also enable the user to view status information concerning the vehicle, such as the status of one or more roadways that are nearby or along a planned route of the vehicle 12.

Vehicle 12 is depicted in the illustrated embodiment as a passenger car, but it should be appreciated that any other vehicle including motorcycles, trucks, sports utility vehicles (SUVs), recreational vehicles (RVs), marine vessels, unmanned aerial vehicles (UAVs), passenger aircrafts, other aircraft, etc., can also be used. Some of the vehicle electronics 20 are shown generally in FIG. 1 and includes a global navigation satellite system (GNSS) receiver 22, a body control module or unit (BCM) 24, an engine control module or unit (ECM) 26, an onboard computer 30, a telematics unit 36, onboard vehicle sensors 42-48, and vehicle-user interfaces 50-56. Some or all of the different vehicle electronics may be connected for communication with each other via one or more communication busses, such as communications bus 40. The communications bus 40 provides the vehicle electronics 20 with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few. In other embodiments, each of the VSMs can communicate using a wireless network and can include suitable hardware, such as short-range wireless communications (SRWC) circuitry.

The vehicle 12 can include numerous vehicle system modules (VSMs) as part of vehicle electronics 20, such as the GNSS receiver 22, the BCM 24, the ECM 26, the onboard computer 30, the telematics unit 36, onboard vehicle sensors 42-48, and vehicle-user interfaces 50-56, which will be described in detail below. The vehicle 12 can also include other VSMs in the form of electronic hardware components that are located throughout the vehicle, and which may receive input from one or more sensors and use the sensed input to perform diagnostic, monitoring, control, reporting, and/or other functions. Each of the VSMs can be connected by the communications bus 40 to the other VSMs. One or more VSMs may periodically or occasionally have their software or firmware updated and, in some embodiments, such vehicle updates may be over the air (OTA) updates that are received from the remote server 78 or the backend facility 80 via land network 76, cellular carrier system 70, and telematics unit 36, for example. As is appreciated by those skilled in the art, the above-mentioned VSMs are only examples of some of the modules that may be used in vehicle 12, as numerous others are also possible.

The global navigation satellite system (GNSS) receiver 22 receives radio signals from a constellation of GNSS satellites 68. The GNSS receiver 22 can be configured to comply with and/or operate according to particular regulations or laws of a given region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 68. And, in another example, GNSS receiver 22 can be a BDS receiver that receives a plurality of GNSS (or BDS) signals from a constellation of GNSS (or BDS) satellites 68. The GNSS receiver 22 can include at least one processor and memory, including a non-transitory computer readable memory storing instructions (software) that are accessible by the processor for carrying out the processing performed by the receiver 22. In one embodiment, the vehicle location can be determined through the GNSS receiver 22 and reported to a remote server, such as the servers 82 at the backend facility 80 and/or the remote server 78.

The GNSS receiver 22 can include at least one processor and memory, including a non-transitory computer readable memory storing instructions (software) that are accessible by the processor for carrying out the processing performed by the GNSS receiver 22. The GNSS receiver 22 can determine a vehicle location, which can be represented in the form of geographical coordinates (e.g., latitude, longitude, elevation). The vehicle location (and other information, such as GNSS time data) can be sent and/or periodically reported to the backed facility 80, which can store the vehicle location.

The body control module (BCM) 24 can be used to control various VSMs of the vehicle, as well as obtain information concerning the VSMs, including their present state(s) or status(es), as well as onboard sensor data. The BCM 24 is shown in the exemplary embodiment of FIG. 1 as being electrically coupled to the communication bus 40. In some embodiments, the BCM 24 may be integrated with or part of a center stack module (CSM), infotainment unit, the onboard computer 30, or other VSMs. Or, the BCM may be a separate device that is connected to other VSMs via the communications bus 40. The BCM 24 can include a processor and/or memory, which can be similar to processor 32 and memory 34 of the onboard computer 30, as discussed below. The BCM 24 may communicate with the onboard computer 30 and/or one or more vehicle system modules (VSMs), such as the engine control module (ECM) 26 and/or the telematics unit 36. Software stored in the memory and executable by the processor enables the BCM 24 to direct one or more vehicle functions or operations including, for example, controlling central locking, air conditioning, power mirrors, controlling the vehicle primary mover (e.g., engine, primary propulsion system), and/or controlling various other vehicle modules.

The engine control module (ECM) 26 may control various aspects of engine operation such as fuel ignition and ignition timing. The ECM 26 is connected to the communications bus 40 and may receive operation instructions (or vehicle commands) from the BCM 24 or other vehicle system modules, such as the onboard computer 30 or other VSMs. In one scenario, the ECM 26 may receive a command from the BCM 24 (or other VSM) to place the vehicle in a primary propulsion on state (from a primary propulsion off state)—i.e., initiate the vehicle ignition or other primary propulsion system (e.g., a battery powered motor). In at least some embodiments when the vehicle is a hybrid or electric vehicle, a primary propulsion control module can be used instead of (or in addition to) the ECM 26, and this primary propulsion control module can be used to obtain status information regarding the primary mover (including electrical motor(s) and battery information). A primary propulsion off state refers to a state in which the primary propulsion system of the vehicle is off, such as when the internal combustion engine is not running or idling, when a vehicle key is not turned to a START or ON (or accessory) position, or when the power control system for one or more electric motors of an electric vehicle is powered off or not enabled. A primary propulsion on state is a state that is not a primary propulsion off state.

Additionally, the BCM 24 and/or the ECM 26 may provide vehicle state information corresponding to the vehicle state or of certain vehicle components or systems, including the VSMs discussed herein. For example, the BCM 24 and/or the ECM 26 may provide the onboard computer 30 and/or the telematics unit 36 with information indicating whether the vehicle is in a primary propulsion on state or a primary propulsion off state, battery information from a vehicle battery system, image data (or other onboard sensor data) from camera(s) 46, water sensor data from water sensor 42, electronic stability control data from electronic stability control sensor 44, lidar/radar information from DAR sensor(s) 48, etc. The information can be sent to the onboard computer 30 and/or the telematics unit 36 (or other vehicle computer/controller) automatically upon receiving a request from the device/computer, automatically upon certain conditions being met, upon a request from another VSM, or periodically (e.g., at set time intervals). The BCM 24 and/or the ECM 26 can also be used to detect the presence of a predetermined vehicle operating condition, which can be carried out by (for example) comparing the predetermined vehicle operating condition (or information pertaining thereto) to current vehicle operating conditions (or present vehicle information). The BCM 24 and/or the ECM 26 can then wake-up or otherwise inform the onboard computer 30 and/or the telematics unit 36 of this event. In other embodiments, the onboard computer 30 and/or the telematics unit 36 can carry out this detecting function based on information received from the BCM 24 and/or the ECM 26.

The onboard computer 30 includes a processor 32 and memory 34. The processor 32 can be used for executing various computer instructions, including those that may be stored on memory 34. The onboard computer 30 is shown as being separate from other VSMs; however, in at least some embodiments, the onboard computer 30 can be a part of or integrated with another VSM of the vehicle electronics 20, such as the sensors 42-48, the BCM 24, an infotainment unit, a center stack module (CSM), the telematics unit 36, etc. In at least one embodiment, the onboard computer 30 carries out one or more steps of the method discussed below.

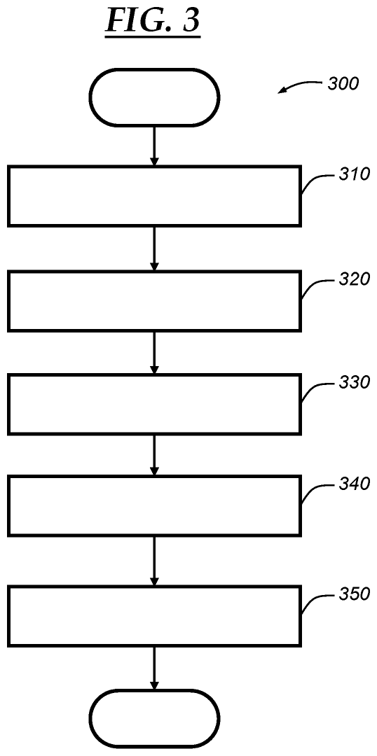

The processor 32 is included as a part of the onboard computer 30 and can be any type of device capable of processing electronic instructions including microprocessors, microcontrollers, host processors, controllers, vehicle communication processors, and application specific integrated circuits (ASICs). It can be a dedicated processor used only for onboard computer 30 or can be shared with other vehicle systems. The processor 32 executes various types of digitally-stored instructions, such as software or firmware programs stored in memory 34, which enable the onboard computer 30 to provide a wide variety of services. For instance, the processor 32 can execute programs or process data to carry out at least a part of the method 300 (FIG. 3) discussed below. The memory 34 may be a temporary powered memory, any non-transitory computer-readable medium, or other type of memory. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives. Similar components to the processor 32 and/or memory 34 can be included in the GNSS receiver 22, the BCM 24, the ECM 26, the telematics unit 36, the onboard vehicle sensors 42-48, and/or various other VSMs that typically include such processing/storing capabilities. Also, in some embodiments, the onboard computer 30 can be integrated with other VSM(s) and, in such embodiments, can share one or more processors and/or memory with the other VSM(s).

The telematics unit 36 is capable of communicating data via cellular network communications through use of a cellular chipset. In at least one embodiment, the telematics unit 36 includes a cellular chipset, a processor, memory, and one or more antennas 38. In one embodiment, the telematics unit 36 may be a standalone module or, in other embodiments, the telematics unit 36 may be incorporated or included as a part of one or more other vehicle system modules, such as a center stack module (CSM), the onboard computer 30, the GNSS receiver 22, BCM 24, the ECM 26, a head unit, an infotainment unit, and/or a gateway module. For example, the GNSS receiver 22 can be integrated into the telematics unit 36 so that, for example, the GNSS receiver 22 and the telematics unit 36 are directly connected to one another as opposed to being connected via the communications bus 40. The telematics unit 36 can be implemented as an OEM-installed (embedded) or aftermarket device that is installed in the vehicle. In some embodiments, the telematics unit 36 can also include short-range wireless communications (SRWC) functionality, and can include a SRWC circuit. In such an embodiment, the telematics unit 36 can establish a SRWC connection with the HWD 90 so that messages can be communicated between the vehicle 12 and the HWD 90. The communications between the vehicle 12 and the HWD 90 can be facilitated by the vehicle user application 92 or other application, for example.

As mentioned above, the telematics unit 36 includes a cellular chipset thereby allowing the device to communicate via one or more cellular protocols, such as those used by wireless carrier system 70. In such a case, the telematics unit is user equipment (UE) that can attach to wireless carrier system 70 and carry out cellular communications, which can enable the vehicle electronics to connect to the backend facility 80 and/or the remote server 78. The telematics unit 36 can include a subscriber identity module (SIM) that can be used for enabling cellular communications with the cellular carrier system 70.

The telematics unit 36 may enable vehicle 12 to be in communication with one or more remote networks (e.g., one or more networks at backend facility 80 or the remote server 78) via packet-switched data communication. This packet-switched data communication may be carried out through use of a non-vehicle wireless access point that is connected to a land network via a router or modem. When used for packet-switched data communication such as TCP/IP, the telematics unit 36 can be configured with a static IP address or can be set up to automatically receive an assigned IP address from another device on the network such as a router or from a network address server.

Packet-switched data communications may also be carried out via use of a cellular network that may be accessible by the telematics unit 36. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known in the art.

The vehicle 12 includes various onboard vehicle sensors 42-48, including a water sensor 42, an electronic stability control sensor 44, a camera 46, and a detection and ranging (DAR) sensor 48. In many embodiments, the vehicle 12 also include other onboard vehicle sensors that are not shown in the illustrated embodiment and/or explicitly discussed herein. Generally, the onboard vehicle sensors can obtain information (or onboard sensor data) pertaining to the operating state of the vehicle (the “vehicle operating state”) and/or the environment of the vehicle (the “vehicle environmental state”). The sensor information can be sent to other VSMs, such as the BCM 24, the onboard computer 30, and/or the telematics unit 36. Also, in some embodiments, the onboard sensor data can be sent with metadata, which can include data identifying the sensor (or type of sensor) that captured the onboard sensor data, a timestamp (or other time indicator), a vehicle location (at which the vehicle was located when the onboard sensor data was captured), and/or other data that pertains to the onboard sensor data, but that does not make up the onboard sensor data itself. The “vehicle operating state” or “vehicle operating conditions” refers to a state of the vehicle concerning the operation of the vehicle, which can include the operation of the primary mover (e.g., a vehicle engine, vehicle propulsion motors) and/or the operation of various VSMs or components of the vehicle. Additionally, the vehicle operating state (or conditions) can include the vehicle state pertaining to mechanical operations of the vehicle or electrical states of the vehicle (e.g., a state informed by sensor information indicating a vehicle door is opened). The “vehicle environmental state” refers to a vehicle state concerning the exterior area surrounding the vehicle. The vehicle environmental state can include traffic conditions (e.g., an amount of traffic for a given roadway), roadway conditions (e.g., ice or snow on the roadways), roadway features (e.g., roadway geometry, traffic signals, lane information), vehicle location, and other vehicle information (e.g., information collected from other nearby vehicles, such as via V2V communications). The vehicle 12 can include one or more environmental sensors, which are onboard vehicle sensors that capture information of the vehicle environmental state.

The water sensor 42 is an environmental sensor that is installed on the vehicle 12 and that can capture information pertaining to standing or flowing water located on a roadway (or other nearby area). The water sensor 42 can be used to detect or otherwise determine the depth of water (or other liquid or precipitation) (e.g., rainwater, snow) along a roadway (or other nearby area). Various types of sensors can be used, such as radar sensors, ultrasonic or sonar sensors, etc. The water sensor 42 can capture water sensor data, which can then be provided to the backend facility 80 via the telematics unit 36.

The movement sensors 44 can be used to obtain movement or inertial information concerning the vehicle, such as vehicle speed, acceleration, yaw (and yaw rate), pitch, roll, and various other attributes of the vehicle concerning its movement as measured locally through use of onboard vehicle sensors. The movement sensors 44 can be mounted on the vehicle in a variety of locations, such as within an interior vehicle cabin, on a front or back bumper of the vehicle, and/or on the hood of the vehicle 12. The movement sensors 44 can be coupled to various other electronic vehicle devices directly or via the communications bus 40. Movement sensor data can be obtained and sent to the other VSMs, including the BCM 24, the onboard computer 30, and/or the telematics unit 36.

In one embodiment, the movement sensors 44 can include wheel speed sensors, which can be installed into the vehicle as an onboard vehicle sensor. The wheel speed sensors are each coupled to a wheel of the vehicle 12 and that can determine a rotational speed of the respective wheel. The rotational speeds from various wheel speed sensors can then be used to obtain a linear or transverse vehicle speed. Additionally, in some embodiments, the wheel speed sensors can be used to determine acceleration of the vehicle and/or the amount of wheel slippage. This wheel slippage data (and/or other onboard sensor data) can be used to collect information pertaining to the traction of the road and can be used to indicate icy or other slippery conditions, for example. In some embodiments, wheel speed sensors can be referred to as vehicle speed sensors (VSS) and can be a part of an anti-lock braking (ABS) system of the vehicle 12 and/or an electronic stability control program. The electronic stability control program can be embodied in a computer program or application that can be stored on a non-transitory, computer-readable memory (such as that which is included in memory of the BCM 24 or another VSM). The electronic stability control program can be executed using a processor of the BCM or another VSM (e.g., the processor 32 of the onboard computer 30) and can use various sensor readings or data from a variety of vehicle sensors including onboard sensor data from onboard vehicle sensors 42-48.

Additionally or alternatively, the movement sensors 44 can include one or more inertial sensors, which can be installed into the vehicle as an onboard vehicle sensor. The inertial sensor(s) can be used to obtain sensor information concerning the acceleration and the direction of the acceleration of the vehicle. The inertial sensors can be microelectromechanical systems (MEMS) sensor or accelerometer that obtains inertial information. The inertial sensors can be used to detect collisions based on a detection of a relatively high deceleration. When a collision is detected, information from the inertial sensors used to detect the collision, as well as other information obtained by the inertial sensors, can be sent to the BCM 24, the onboard computer 30, the telematics unit 36, or other VSM of the vehicle electronics. Additionally, the inertial sensor can be used to detect a high level of acceleration or braking. In one embodiment, the vehicle 12 can include a plurality of inertial sensors located throughout the vehicle. And, in some embodiments, each of the inertial sensors can be a multi-axis accelerometer that can measure acceleration or inertial force along a plurality of axes. The plurality of axes may each be orthogonal or perpendicular to one another and, additionally, one of the axes may run in the direction from the front to the back of the vehicle 12. Other embodiments may employ single-axis accelerometers or a combination of single- and multi- axis accelerometers. Other types of sensors can be used, including other accelerometers, gyroscope sensors, and/or other inertial sensors that are known or that may become known in the art.

The movement sensors 44 can include one or more yaw rate sensors, which can be installed into the vehicle as an onboard vehicle sensor. The yaw rate sensor(s) can obtain vehicle angular velocity information with respect to a vertical axis of the vehicle. The yaw rate sensors can include gyroscopic mechanisms that can determine the yaw rate and/or the slip angle. Various types of yaw rate sensors can be used, including micromechanical yaw rate sensors and piezoelectric yaw rate sensors.

The movement sensors 44 can also include a steering wheel angle sensor, which can be installed into the vehicle as an onboard vehicle sensor. The steering wheel angle sensor is coupled to a steering wheel of vehicle 12 or a component of the steering wheel, including any of those that are a part of the steering column. The steering wheel angle sensor can detect the angle that a steering wheel is rotated, which can correspond to the angle of one or more vehicle wheels with respect to a longitudinal axis that runs from the back to the front of the vehicle 12. Sensor data and/or readings from the steering wheel angle sensor can be used in the electronic stability control program that can be executed on a processor of the BCM 24 or another processor of the vehicle electronics 20.

Vehicle camera(s) 46 is/are environmental sensor(s) that are mounted on vehicle 12 and that is/are any suitable digital camera known or used in the industry. According to a non-limiting example, the vehicle 12 includes a collection of CMOS cameras or image sensors 46 located around the vehicle, including a number of forward-facing CMOS cameras that provide digital images that can be subsequently stitched together to yield a 2D or 3D representation of the road and environment in front and/or to the side of the vehicle. The vehicle camera(s) 46 may provide vehicle video data to one or more components of the vehicle electronics 20, including to the BCM 24, the onboard computer 30, and/or the telematics unit 36. Depending on the particular application, the vehicle camera(s) 46 may be: a still camera, a video camera, and/or some other type of image generating device; a BW and/or a color camera; a front-, rear- side- and/or 360°-facing camera; part of a mono and/or stereo system; an analog and/or digital camera; a short-, mid- and/or long-range camera; and a wide and/or narrow FOV (aperture angle) camera, to cite a few possibilities. In one example, each vehicle camera 46 outputs raw vehicle video data, whereas in other examples each vehicle camera 46 includes image processing resources and performs pre-processing on the captured images before outputting them as vehicle video data.

The detection and ranging (DAR) sensor(s) 48 is/are environmental sensors that include one or more lidar units and/or radar units, each of which is a VSM of the vehicle electronics 20 that includes an emitter and a receiver. The DAR sensor(s) 48 may be mounted (or installed) on the front of the vehicle 12. In such an embodiment, the DAR sensor(s) 48 can face an area in front of the vehicle 12 such that the field of view of the DAR sensor(s) 48 include this area. The DAR sensor(s) 48 can be positioned in the middle of the front bumper of the vehicle 12, to the side of the front bumper of the vehicle 12, on the sides of the vehicle 12, on the rear of the vehicle 12 (e.g., a rear bumper), etc. Additionally, or alternatively, one or more DAR sensor(s) can be positioned at other areas around the vehicle, such as to the sides of the vehicle, to the rear of the vehicle, on top of the vehicle, etc. As mentioned, the DAR sensor(s) can include one or more lidar units, which can be used, which can emit non-visible light waves for purposes of object detection. Each lidar unit operates to obtain spatial or other physical information regarding one or more objects within the field of view of the lidar unit through emitting light waves and receiving the reflected light waves. In many embodiments, each lidar unit emits a plurality of light pulses (e.g., laser light pulses) and receives the reflected light pulses using a lidar receiver. Moreover, the lidar data captured by the lidar unit(s) can be represented in a pixel array (or other similar visual representation). The lidar unit(s) can capture static lidar images and/or lidar image or video streams. Also, the DAR sensor(s) 48 can include one or more radar units, which can each use radio waves to obtain spatial or other physical information regarding one or more objects within the field of view of the radar unit. The radar unit can include a separate receiving antenna, or the radar unit can include a single antenna for both reception and transmission of radio signals. And, in other embodiments, the radar unit can include a plurality of transmitting antennas, a plurality of receiving antennas, or a combination thereof so as to implement multiple input multiple output (MIMO), single input multiple output (SIMO), or multiple input single output (MISO) techniques.

Additionally, the vehicle 12 can include other sensors not mentioned above, including parking sensors, lane change and/or blind spot sensors, lane assist sensors, ranging sensors (i.e., sensors used to detect the range between the vehicle and another object, such as through use of radar or lidar), security- or theft- related sensors, tire-pressure sensors, fluid level sensors (e.g., a fuel or gas level sensor, a windshield wiper fluid level sensor), brake pad wear sensors, rain or precipitation sensors (e.g., infrared light sensor(s) directed toward the windshield (or other window of the vehicle 12) to detect rain or other precipitation based on the amount of reflected light), and interior or exterior temperature sensors.

The vehicle electronics 20 also includes a number of vehicle-user interfaces that provide vehicle occupants with a means of providing and/or receiving information, including the visual display 50, pushbutton(s) 52, microphone(s) 54, and the audio system 56. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the telematics unit 36 to provide other data, response, or control input. However, one or more of the pushbutton(s) 52 can be connected to one or more other VSMs and/or the communications bus 40. The audio system 56 provides audio output to a vehicle occupant and can be a dedicated, stand-alone system or part of the primary vehicle audio system. According to the particular embodiment shown here, the audio system 56 is operatively coupled to both communications bus 40 and an entertainment bus (not shown) and can provide AM, FM and satellite radio, CD, DVD and other multimedia functionality. This functionality can be provided in conjunction with or independent of an infotainment module. The microphone(s) 54 provide audio input to the vehicle electronics 20 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 can be a graphics display and can be used to provide a multitude of input and output functions. Display 50 can be a touch screen on the instrument panel, a heads-up display reflected off of the windshield, or a projector that can project graphics for viewing by a vehicle occupant. The vehicle-user interfaces can be used to provide notifications and/or warnings to the vehicle users, and/or to obtain input or other data from the vehicle users. Various other human-machine interfaces for providing input from a human to the vehicle as the interfaces of FIG. 1 are only an example of one particular implementation.

With reference to FIG. 2, there is shown a method 200 of causing a responsive vehicle action to be carried out at one or more affected vehicles in response to an emergency event. In one embodiment, the method 200 (or any steps thereof) is carried out by the backend facility 80. Additionally or alternatively, one or more of the steps of the method 200 can be carried out by other devices or systems, such as the remote server(s) 78. Although the steps of the method 200 are described as being carried out in a particular order, it is hereby contemplated that the steps of the method 200 can be carried out in any suitable order as will be appreciated by those skilled in the art.

The method 200 begins with step 210, wherein an emergency event indication is received. The emergency event indication is an indication of an emergency event has occurred, is about to occur, or is ongoing. The emergency event indication can be received at the backend facility 80. In at least one embodiment, the emergency event indication is generated or provided by an emergency/crisis monitoring team, which can include staff members that monitor for emergencies and/or crises, such as through monitoring news outlets and/or other reporting services. In such instances, a staff member can provide input into a computer network or system (e.g., such as those located at the backend facility 80) so as to provide the emergency event indication. In other embodiments, the emergency event indication can be automatically or programmatically generated based on certain predefined conditions being met, such as certain weather conditions reaching extreme levels (e.g., an ice storm with a very high level of ice accumulation) and/or based on information reported by one or more vehicles (e.g., through analyzing onboard sensor data, such as camera or lidar/radar data). In one embodiment, this automatically-generated emergency event indication is generated based on information received from one or more servers that are remote from the backend facility 80, such as the remote server(s) 78.

In one embodiment, the emergency event indication can be accompanied with (or can include) an emergency event location and emergency event type. The emergency event location is information that indicates a location or region that is affected by the emergency event. In one embodiment, the emergency event location can include a plurality of geographical coordinates that define a bounding polygon (or area). In another embodiment, the emergency event location can include a single geographical coordinate that is accompanied by a range (or radius) value. In another embodiment, counties (e.g., Oakland County of Michigan) or other predefined geographical areas or boundaries can be used as the emergency event location, where appropriate. Also, other types of information can be used as the emergency event location and/or to define the affected location or region. The emergency event type specifies the type or classification of the emergency event, which can be, for example, a forest fire or other fire/explosion, collapsed or impassible bridges or other roadways, flooded roadways, etc. Examples of emergency event types can include a weather-related emergency event and an infrastructure-related emergency event (e.g., a collapsed bridge). Moreover, these emergency event types can be further broken down into subtypes, such as an ice-related emergency event, a flood-related emergency event, a tornado emergency event, a hurricane emergency event, a snow-related emergency event, an impassible road emergency event, etc. The emergency event types and emergency event location(s) can be stored in the databases 84, for example. The method 200 then continues to step 220.

In step 220, one or more probe vehicles are identified based on their relationship to the emergency event location. The probe vehicles are vehicles that are identified as being those vehicles located near or at an emergency event location (e.g., the emergency event location), and/or are en route to or through an emergency event location. The probe vehicles can be identified based on vehicle location data that is stored at a remote server, such as those servers 82 at the backend facility 80 or remote server(s) 78. The vehicle location data (including current vehicle location and vehicle route information (e.g., departure location, destination, one or more roadway segments therebetween)) for a fleet of vehicles (e.g., those vehicles of a particular OEM) can be continuously sent from each of the vehicles to the remote server and stored in a database. Then, upon step 220, the probe vehicle(s) can be identified based on their proximity to the emergency event location and/or a route in which the vehicle is traveling along. This vehicle route information can also be stored at the remote server, such as in a database. In one embodiment, the HWD 90 provides the vehicle route information to the backend facility 80. The method 200 then continues to step 230.

In step 230, a data request is sent to each of the identified probe vehicles. The data request is a request to obtain probe data from the vehicle to which the data request is sent. The data request can include any information sufficient to elicit a data response from the vehicle to which it is sent. In some embodiments, the data request can specify certain data request parameters, which are parameters specifying or otherwise indicating a particular type or kind of data (e.g., a particular type of data) (or probe data type), a particular source of data (e.g., a particular sensor) (or probe data source), and/or a probe data location. The probe data location is a location to which the probe data concerns. For example, a particular lane of a particular segment of a roadway can be identified by the probe data location and then used by the vehicle to obtain probe data pertaining to this identified segment of the roadway. The particular type or kind of data (referred to as the “probe data type”) specifies a type or kind of probe data that is requested, such as water sensor data (e.g., which can be useful in the case of a flood-related emergency event). The particular source of data (referred to as the “probe data source”) specifies a particular source from which the probe data is initially obtained or captured, such as one or more particular sensors or group of sensors of the vehicle (e.g., the lidar units, the left-facing camera, the forward-facing radar). In one embodiment, the data request can be tailored to the particular vehicle to which it is sent, which can be based on the type of onboard vehicle sensors, for example. In one embodiment, the data request(s) are sent over the land network 76 and the wireless carrier system 70, and then received at the telematics unit 36 of the vehicle 12. The method 200 then continues to step 240.

In step 240, a data response is received from one or more of the identified vehicles to which the data requests were sent. The data response includes probe data that is obtained by the probe vehicle. In response to receiving the data request, the vehicle 12 can obtain the requested probe data, which can include capturing onboard sensor data from one or more onboard vehicle sensors (e.g., sensors 42-48) and/or recalling data from memory (e.g., memory of the BCM 24, memory 34 of the onboard computer 30). The vehicle can then package the probe data and send the probe data back to the remote server that sent the data request, or another remote device or server, which can be designated in the data request or stored locally on the vehicle. In one embodiment, the data response(s) are sent over the land network 76 and the wireless carrier system 70 and received at the backend facility 80 or other remote server. The method 200 then continues to step 250.

In step 250, one or more affected vehicles are identified based on the probe data and/or the emergency event indication. The affected vehicles are vehicles that are identified as being those vehicles located near or at an identified emergency location (e.g., the emergency event location), en route to or through an identified emergency location, and/or reside near or at an identified emergency location. The vehicle location of a fleet of vehicles can be determined using those same techniques discussed above with respect to the probe vehicles. In some embodiments, the probe vehicles and the affected vehicles can be determined to be the same vehicles and, in one embodiment, a single determination can be made as to which vehicles are considered the probe/affected vehicles. However, in at least some embodiments, and according to at least some scenarios, the affected vehicles includes vehicles that are not probe vehicles and the probe vehicles include vehicles that are not affected vehicles, although some overlap may exist.

As mentioned, in one embodiment, the affected vehicles can be identified based on their location or proximity to the emergency event location. Additionally, at least in some embodiments, the vehicles can be identified based on a planned route for the vehicle, which can be specified in the vehicle route information. For example, if the planned route includes segments of a roadway that are at or within the emergency event location, then the vehicle can be identified as an affected vehicle. Additionally, in some embodiments, a vehicle can be associated with a designated residence and, when it is determined that the designated residence is at or within the emergency event location, the associated vehicle can be identified as an affected vehicle. Any combination of these (or other) various types of identifying whether a vehicle is an affected vehicle can be used as well. The method 200 then continues to step 260.

In step 260, a responsive vehicle action message is sent to the affected vehicle(s). The responsive vehicle action message is a message that causes or directs the vehicle to carry out a responsive vehicle action. The responsive vehicle action can be any of a variety of vehicle actions, including, for example, presenting a notification (e.g., warning) to the vehicle user, carrying out or adjusting certain vehicle functions (e.g., providing information to an electronic stability control module in anticipation of slippery roads), carrying out or adjusting autonomous vehicle (AV) functionality, rerouting the vehicle (e.g., determining another route that avoids the emergency event location), etc.

In one embodiment, the responsive vehicle action can be tailored to the particular affected vehicle to which the responsive vehicle action message is to be sent. For example, the responsive vehicle action can be determined based on certain characteristics of the affected vehicle, such as vehicle physical attribute information for the affected vehicle. As mentioned above, vehicle physical attribute information for a plurality (or fleet) of vehicles can be stored in databases 84 (or other database(s) or memory of another remote server). In one embodiment, one or more affected vehicles are identified based on their location and, then, vehicle physical attribute information for each of the one or more affected vehicles can be obtained or queried from the database(s). Then, the vehicle physical attribute information can be used to determine a particular responsive vehicle action that is tailored to that vehicle. For example, when the emergency event type is a flood-related emergency event type, then water sensor data can be gathered from the probe vehicles (see steps 230-240). The water sensor data can be used to determine a minimum underbody clearance height that is considered suitable for vehicles to pass through. The minimum underbody clearance height is an example of a vehicle physical attribute that can be stored as a part of vehicle physical attribute information. Thus, the vehicle physical attribute data can be used to determine which of the affected vehicles have an underbody clearance height that is equal to or greater than the minimum underbody clearance height. For those affected vehicles that have an underbody clearance height that is less than the minimum underbody clearance height, the responsive vehicle action message can include instructions or a request to re-route the affected vehicle away from and/or around the emergency event location. For those affected vehicles that have an underbody clearance height that is equal to or greater than the minimum underbody clearance height, the responsive vehicle action messages can include or cause the vehicle to provide a warning or other notification to the vehicle users. This warning or other notification is an example of a responsive vehicle action.

In some embodiments, the plurality (or fleet) of vehicles can be compared to the probe vehicles. For example, in one embodiment, a first vehicle of a first model/model-year can be determined to be a probe vehicle that has recently passed through the emergency event location during the emergency event. This probe vehicle (or the first vehicle) can then transmit probe data to the remote server, which can include the probe vehicle location (i.e., the location of the probe vehicle) and other information, such as onboard sensor data and/or other operating information. The remote server can then identify one or more affected vehicles (the second vehicle(s)) that are of the same model/model-year as the probe vehicle (or the first vehicle) and, based on the probe data received from this vehicle (and/or other probe data or other information), one or more responsive vehicle actions can be determined for the affected vehicle(s) (the second vehicle(s)). In other embodiments, other vehicle model information or other characteristics of the probe vehicles/affected vehicles can be used to identify or determine suitable responsive vehicle actions. Moreover, in at least some embodiments, determining a responsive vehicle action can be further based on other emergency event information, such as the emergency event type, weather information, traffic information, edge sensor data (i.e., sensor data received from one or more edge sensors located along one or more roadways), emergency systems data, roadway attributes of the emergency event location, etc. The method 200 then ends.

With reference to FIG. 3, there is shown a method 300 of causing a responsive vehicle action to be carried out at one or more affected vehicles in response to an emergency event. In one embodiment, the method 300 (or any steps thereof) is carried out by the onboard computer 30. Additionally or alternatively, one or more of the steps of the method 300 can be carried out by other VSMs of the vehicle electronics 20. Although the steps of the method 300 are described as being carried out in a particular order, it is hereby contemplated that the steps of the method 300 can be carried out in any suitable order as will be appreciated by those skilled in the art.

The method 300 begins with step 310, wherein a data request is received from a remote server. The data request is discussed above with respect to step 230 of the method 200. As mentioned above, in one embodiment, the data request is received at the telematics unit 36 of the vehicle 12. Once the data request is received at the vehicle, the vehicle can store information contained in the data request and/or process the data request so as to determine probe data that is to be collected and/or sent to the remote server. The method 300 then continues to step 320.

In step 320, probe data is obtained in response to the data request. As mentioned above, the data request can specify a probe data source, a probe data type, and/or a probe data location. In some embodiments, the probe data can be obtained from recalling data or other information from a memory device included as a part of the vehicle electronics 20, such as the memory 34 of the onboard computer 30 or the memory of the BCM 24. Additionally or alternatively, the vehicle can use onboard vehicle sensors (e.g., onboard vehicle sensors 42-48) to capture onboard sensor data, which can be included as at least part of the probe data.

In some embodiments, the vehicle can use short-range wireless communication (SRWC) circuitry to communicate with one or more nearby vehicles or other wireless devices to collect probe data. For example, in one embodiment, the vehicle can carry out vehicle-to-vehicle (V2V) communications with other nearby vehicles or other devices so as to obtain probe data from these other vehicles or devices. This probe data from the other vehicles can include onboard vehicle sensor data that is collected by the other nearby vehicles, and/or may include sensor data (or other data) from one or more edge computing systems (e.g., roadside units and/or associated sensors). The method 300 then continues to step 330.

In step 330, the data response is sent to a remote server. This remote server can be the same remote server that sent the data request, or may be a different server, as discussed above. In one embodiment, the data response is sent from the telematics unit 36 to the remote server via wireless carrier system 70 and land network 76. The method 300 then continues to step 340.

In step 340, the vehicle receives a responsive vehicle action message from a remote server. In at least some embodiments, this remote server can be the same remote server (or from the same backend facility or remote server system) as the remote server discussed above in steps 310 and/or 330. The responsive vehicle action message and the responsive vehicle action are discussed above with respect to step 260 of the method 200 (FIG. 2). Data or other information included in the responsive vehicle action message (or otherwise indicated by the responsive vehicle action message) can be sent to one or more VSMs of the vehicle, such as the BCM 24, the onboard computer 30, the onboard vehicle sensors 42-48, the vehicle-user interfaces 50-56, and/or the HWD 90 (via a SRWC connection with the vehicle 12). The method 300 then continues to step 350.

In step 350, the responsive vehicle action as indicated by the responsive vehicle action message is carried out. The responsive vehicle action can be carried out in a number of ways, which can depend on the particular responsive vehicle action that is to be carried out. In one embodiment, the responsive vehicle action is a notification action in which one or more vehicle users are notified. The notification can be provided using one or more of the vehicle-user interfaces 50-56 of the vehicle, for example. In another embodiment, the notification (or information indicating the contents or type of notification) can be sent to the HWD 90 and the HWD 90 can then provide a notification to the user using a display or speakers, for example. In one embodiment, the notification action is an override warning action, which includes stopping or preventing output from one or more vehicle-user interfaces (e.g., vehicle user interfaces 50-52 and 56) as well as providing a warning or other notification using one or more of these vehicle-user interfaces. For example, if the radio or other media is being played using audio system 56, in response to receiving the responsive vehicle action message, the radio or other media can be stopped (i.e., not output using the audio system 56) and the warning or other notification (as indicated by the responsive vehicle action message) can be presented using the audio system 56 and/or the display 50.

In another embodiment, the responsive vehicle action is a vehicle action that causes a change in the vehicle's operation, such as a change in the vehicle's driving output. For example, the responsive vehicle action can direct the electronic stability control system to operate in a particular mode or to adjust certain operating parameters. As another example used in the case where the vehicle is an autonomous vehicle (e.g., semi-autonomous vehicle, fully autonomous vehicle), the responsive vehicle action can direct or adjust one or more autonomous vehicle (AV) functions or actions, such as re-routing the vehicle away from the emergency event location and/or driving in a particular lane, which can be specified by the responsive vehicle action message. In other embodiments, the responsive vehicle action can (merely) specify parameters to use when carrying out certain vehicle functionality, such as certain AV functions or actions. The method 300 then ends.

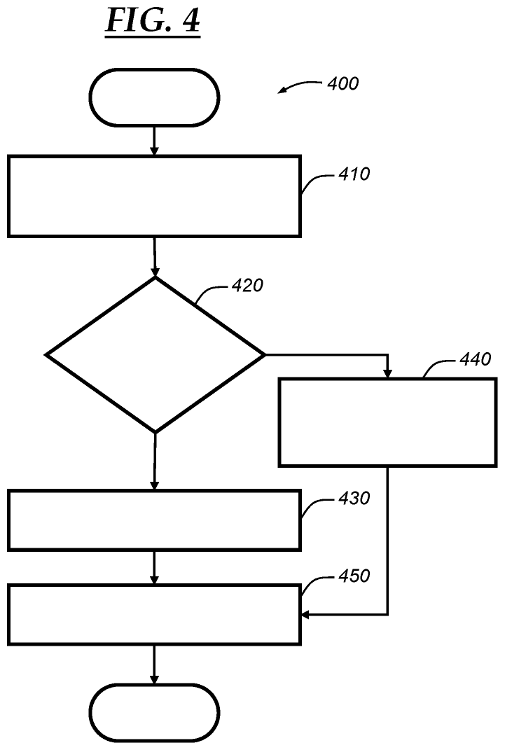

With reference to FIG. 4, there is shown a process 400 for carrying out a responsive vehicle action for an autonomous vehicle that can be used with the method 200 (FIG. 2) and/or the method 300 (FIG. 3). An autonomous vehicle (AV) is a vehicle that is at least party semi-autonomous, including fully autonomous vehicles. In one embodiment, the process 400 can be carried out for any affected autonomous vehicle or, in another embodiment, the process 400 can be carried out for any affected highly autonomous vehicle (i.e., those vehicles above a level 3 according to SAE International's standard J3016). Although the steps of the process 400 are described as being carried out in a particular order, it is hereby contemplated that the steps of the process 400 can be carried out in any suitable order as will be appreciated by those skilled in the art.

The process 400 begins with step 410, wherein one or more enhanced autonomous features are activated. The enhanced autonomous features can include one or more AV driving features that are adapted based on emergency event information and, in at least one embodiment, these enhanced autonomous features can be specified in the responsive vehicle action message and/or may be carried out or activated in response to the responsive vehicle action message. In another embodiment, one or more enhanced autonomous features can be determined to be activated or carried out based on information included in another message from a remote server. As an example, an enhanced autonomous feature can be an enhanced AV driving feature that is adapted to provide AV functionality tailored to propelling the vehicle over slippery roadways. In one embodiment, the enhanced AV driving feature can be activated based on information included as a part of the responsive vehicle action message. The process 400 then continues to step 420.

In step 420, it can be determined whether to proceed with AV driving functionality. In one embodiment, a determination can be made as to whether it is too dangerous or risky to proceed with AV driving functionality. This determination can be made locally at the vehicle, or may be made at a remote server and communicated to the vehicle, such as a part of the responsive vehicle action message. In one embodiment, the vehicle can use onboard sensor data to assess whether the roadway conditions are too dangerous or risky for continuing to carry out AV driving functionality, or whether to otherwise proceed with AV driving functionality. When it is determined not to proceed with AV driving functionality, the process 400 then continues to step 430. Otherwise, the process 400 then continues to step 440.

In step 430, the AV driving functionality is disabled. This can include switching the control from the vehicle from an AV control unit to manual driving inputs, such as a steering wheel, a brake pedal, and a gas/throttle pedal. A notification can also be presented to a vehicle operator informing the vehicle operator that the vehicle is switching to manual control. In one embodiment, the vehicle can use AV driving functionality to bring the vehicle to a stop so as to more safely transition from AV driving functionality to manual driving. The process 400 then continues to step 450.

In step 440, emergency event information and/or access to an advisor is provided to the affected vehicle. In one embodiment, the emergency event information can be provided from a remote server, and can include a warning or other notification, such as those discussed above. Additionally or alternatively, access to an advisor (e.g., an individual located at a backend office) can be provided, which can be in the form of a hands-free voice call. In other embodiments, access to an advisor and/or the emergency event information can be provided to the vehicle while carrying out AV driving functionality. The process 400 then continues to step 450.

In step 450, the vehicle receives an indication that the emergency event has ended. In one embodiment, this indication can be received as a part of a message from a remote server, such as one of the servers 82 of the backend facility 80. In one embodiment, the vehicle can resume a route that was previously modified due to the presence of the emergency event. For example, a route of the vehicle may be modified as a part of the responsive vehicle action. However, if the vehicle receives an indication that the emergency event has ended prior to the end of the route, the original route can be resumed since the emergency event has ended. Other vehicle functionality can be carried out in response to this indication of the end of the emergency event as well. The process 400 then ends.

In one embodiment, the method 200 and/or the method 300 can be modified such that the probe vehicles continuously obtain and send probe data back to the backend facility. The probe vehicles can then stop obtaining and sending probe data back to the backend facility when the vehicle receives an indication that the emergency event has ended, or when the remote server provides an indication to stop sending the probe data.

In one embodiment, the method 200 and/or the method 300 can be modified such that a remote server (e.g., any of those discussed in steps 210-260) can continuously send emergency event data or other information to the probe vehicles and/or the affected vehicles. Any or all of this emergency event data can be presented to a vehicle user via one or more vehicle-user interfaces, or may be used by the vehicle for carrying out vehicle functionality. Also, in some embodiments, emergency event data updates can be periodically sent or sent in response to the remote server receiving updated emergency event data. This emergency event data and/or the updated emergency event data can include one or more emergency event locations, an emergency event type, and/or other information relating to the emergency event. In one embodiment, the updated emergency event data can be determined based on probe data collected from one or more probe vehicles. In one embodiment, the emergency event data updates can be tailored to a particular vehicle and/or can include route updates for that vehicle (or a set of vehicles).

In one embodiment, the method 200 and/or the method 300 can be modified such that the vehicle can report the vehicle location when the vehicle is trapped or otherwise not moveable/drivable away from an emergency event location. For example, the water sensor(s) 42 can implement a flood detection feature where the water sensor(s) 42 detect the presence of water above a certain threshold height and, when this happens, the vehicle can determine its vehicle location (e.g., using GNSS receiver 22) and then report this vehicle location (and/or other information, such as onboard sensor data) to a remote server or backend facility.

In one embodiment, the method 200 and/or the method 300 can be modified such that the vehicle can provide live (i.e., real-time, continuously streamed) onboard sensor data (or other operating information) to a remote server and/or advisor. For example, a camera stream can be continuously streamed to the remote server for viewing by an advisor using a graphical user interface (GUI) of a backend advisor computer application. Other vehicle data can be presented to the advisor as well.

In one embodiment, the responsive vehicle action message can indicate, specify, or include one or more (e.g., a plurality of) responsive vehicle actions to be carried out by the affected vehicle(s). Also, in one embodiment, at least one responsive vehicle action is determined based on the probe data that is received from at least one of the one or more probe vehicles. Also, in some embodiments, when the vehicle physical attribute information of the first probe vehicle is the same as (or corresponds to) the vehicle physical attribution information of the one or more affected vehicles, then the responsive action can be determined based on probe data received from the first probe vehicle. For example, when the first probe vehicle has successfully passed through an emergency event location (e.g., a flooded roadway) and the first probe vehicle has the same (i.e., the same or classified as the same, such as within a range of values) underbody clearance height (an example of vehicle physical attribute information), then it can be determined that the one or more affected vehicles with the same underbody clearance height may be suitable for passing through the emergency event location.

In one embodiment, the method 200, the method 300, the process 400, and/or step(s) or parts thereof can be implemented in one or more computer programs (or “applications”, or “scripts”) embodied in one or more computer readable mediums and including instructions usable (e.g., executable) by one or more processors of the one or more computers of one or more systems. The computer program(s) may include one or more software programs comprised of program instructions in source code, object code, executable code, or other formats. In one embodiment, any one or more of the computer program(s) can include one or more firmware programs and/or hardware description language (HDL) files. Furthermore, the computer program(s) can each be associated with any program related data and, in some embodiments, the computer program(s) can be packaged with the program related data. The program related data may include data structures, look-up tables, configuration files, certificates, or other relevant data represented in any other suitable format. The program instructions may include program modules, routines, programs, functions, procedures, methods, objects, components, and/or the like. The computer program(s) can be executed on one or more computers, such as on multiple computers that are in communication with one another.

The computer program(s) can be embodied on computer readable media (e.g., memory of the vehicle 12 (e.g., memory 34), other vehicle memory, memory of the remote server 78, memory of the backend facility 80, a combination thereof), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

What is claimed is:

1. A method of causing a responsive vehicle action to be carried out at one or more affected vehicles in response to an emergency event, wherein the method comprises the steps of:
identifying one or more probe vehicles in response to an emergency event indication, wherein the one or more probe vehicles are selected based on a proximity between an emergency event location of the emergency event and the one or more vehicles or a route of the one or more vehicles;
sending a data request to the one or more probe vehicles, wherein the data request indicates to the one or more probe vehicles to send probe data to a remote server;
receiving a data response from the one or more probe vehicles at the remote server, wherein the data response includes the probe data, and wherein the probe data is based on onboard sensor data obtained from one or more onboard vehicle sensors; and
sending a responsive vehicle action message to each of the one or more affected vehicles, wherein the responsive vehicle action message specifies one or more responsive vehicle actions to be carried out by the affected vehicle to which the responsive vehicle action message is sent, wherein at least one of the one or more responsive vehicle actions are determined based on the probe data.

2. The method of claim 1, further including the step of receiving the emergency event indication, wherein the emergency event indication includes the emergency event location and an emergency event type.

3. The method of claim 2, wherein the data request is generated based on the emergency event type.

4. The method of claim 3, wherein the responsive vehicle action is determined based on the emergency event type and/or the probe data.

5. The method of claim 4, wherein the responsive vehicle action is determined based on vehicle physical attribute information that is stored in a database of a remote facility.

6. The method of claim 1, wherein the one or more affected vehicles are selected based on a proximity to the emergency event location, whether a planned route of the vehicle passes through the emergency event location, and/or whether the vehicle resides at, within, or near the emergency event location.

7. The method of claim 1, wherein the data request specifies a probe data type, a probe data source, and/or a probe data location.

8. The method of claim 7, wherein the probe data source specifies a particular onboard vehicle sensor that is to be used to collect the probe data.

9. The method of claim 1, wherein at least one of the responsive vehicle actions specified in the responsive vehicle action message sent to a first affected vehicle is determined based on vehicle physical attribute information of the first affected vehicle.

10. The method of claim 9, wherein the at least one responsive vehicle action is determined based on the probe data that is received from a first one of the one or more probe vehicles, wherein vehicle physical attribute information of the first probe vehicle is the same as or corresponds to the vehicle physical attribute information of the first affected vehicle.

11. The method of claim 1, wherein the probe data of at least one of the data responses from a first probe vehicle of the one or more probe vehicles includes vehicle-to-vehicle (V2V) data that is obtained by the first probe vehicle using short-range wireless communication (SRWC) circuitry.

12. The method of claim 1, further comprising sending emergency event data updates periodically to one or more of the probe vehicle(s) and/or the affected vehicle(s) in response to the remote server receiving updated emergency event data.

13. A method of causing a responsive vehicle action to be carried out at one or more affected vehicles in response to an emergency event, wherein the method comprises the steps of:
receiving a data request from a backend facility at a first vehicle, wherein the data request indicates to the one or more probe vehicles to send probe data to the backend facility, and wherein the data request is generated at the backend facility in response to an emergency event indication;
obtaining onboard sensor data from one or more onboard vehicle sensors of the vehicle;
generating a data response at the vehicle based on the onboard sensor data, wherein the data response includes the probe data, and wherein the probe data includes the onboard sensor data or data based on the onboard sensor data; and
sending the data response to the backend facility, wherein at least some of the probe data of the data response is used by the backend facility to generate one or more responsive vehicle action messages that each specify one or more responsive vehicle actions to be carried out by one or more affected vehicles to which the responsive vehicle action message is sent.

14. The method of claim 13, wherein the method is carried out by the first vehicle, and wherein the first vehicle is a probe vehicle.

15. The method of claim 14, wherein the onboard vehicle sensors include an environmental sensor that captures information of a vehicle environmental state.

16. The method of claim 15, wherein the environmental sensor is a water sensor, a lidar unit, a radar unit, or a camera.

17. The method of claim 13, wherein the first vehicle is one of the one or more affected vehicles, wherein the method further comprises the steps of:
receiving a first one of the responsive vehicle action messages from the backend facility; and
carrying out the responsive vehicle action specified in the first responsive vehicle action message.

18. The method of claim 17, wherein the first responsive vehicle action message is generated based on the probe data included in the data response received at the backend facility from the first vehicle.

19. The method of claim 18, wherein the first responsive vehicle action message is generated based on probe data included in another data response received at the backend facility from another probe vehicle.

20. The method of claim 13, wherein the first vehicle is an autonomous vehicle (AV), wherein the first vehicle determines whether to continue AV driving functionality based on emergency event information received from the backend facility.
